(19) United States
(12) Patent Application Publication
(10) Pub. No.: US 2010/0202659 A1
(43) Pub. Date: Aug. 12, 2010

(54) IMAGE SAMPLING IN STOCHASTIC MODEL-BASED COMPUTER VISION

(76) Inventor: Perttu Hämäläinen, Helsinki (FI)

Correspondence Address: Muncy, Geissler, Olds & Lowe, PLLC, 4000 Legato Road, Suite 310, FAIRFAX, VA, 22033, US

(21) Appl. No.: 12/664,847

(22) PCT Filed: Jun. 13, 2008
(86) PCT No.: PCT/FI08/50362

§ 371 Date: Apr. 15, 2010

(30) Foreign Application Priority Data
Jun. 15, 2007 (FI) 20075453

(51) Int. Cl. G06K 9/00

(52) U.S. Cl. 382/103

(57) ABSTRACT

A method for tracking a target in computer vision is disclosed. The method generates an integral image (22) based on the input image. Then the image is split into portions (24). For each new portion a definite integral corresponding to the portion is computed using an integral image (25). Based on the definite integrals a new portion is chosen for splitting (26). The new portion is processed correspondingly and the processing is repeated until a termination condition is reached (27).

### FIELD OF THE INVENTION

This invention is related to random number generating, optimization, and computer vision.

### BACKGROUND OF THE INVENTION

Computer vision has been used in several different application fields. Different applications require different approaches as the problem varies according to the applications. For example, in quality control a computer vision system uses digital imaging for obtaining an image to be analyzed. The analysis may be, for example, a color analysis for paint or the number of knot holes in plank wood.

One possible application of computer vision is model-based vision wherein a target, such as a face, needs to be detected in an image. It is possible to use special targets, such as a special suit for gaming, in order to facilitate easier recognition. However, in some applications it is necessary to recognize natural features from the face or other body parts. Similarly it is possible to recognize other objects based on the shape or form of the object to be recognized. Recognition data can be used for several purposes, for example, for determining the movement of an object or for identifying the object.

The problem in such model-based vision is that it is computationally very difficult. The observations can be in different positions. Furthermore, in the real world the observations may be rotated around any axis. Thus, a simple model and observation comparison is not suitable as the parameter space is too large for an exhaustive search.

Previously this problem has been solved by optimization and Bayesian estimation methods, such as genetic algorithms and particle filters. Drawbacks of the prior art are that the methods require too much computing power for many real-time applications and that finding the optimum model parameters is uncertain.

In order to facilitate the understanding of the present invention the mathematical and data processing principles behind the present invention are explained.

This document uses the following mathematical notation

x vector of real values

x^{T} vector x transposed

x⁽ⁿ⁾ the nth element of x

A matrix of real values

a^{(n,k)} element of A at row n and column k

[a,b,c] a vector with the elements a, b, c

f(x) fitness function

E[x] expectation (mean) of x

std[x] standard deviation (stdev) of x

[x] absolute value of x

In computer vision, an often encountered problem is that of finding the solution vector x with k elements that maximizes or minimizes a fitness function f(x). Computing f(x) depends on the application of the invention. In model-based computer vision, x can contain the parameters of a model of a tracked target. Based on the parameters, f(x) can then be computed as the correspondence between the model and the perceived image, high values meaning a strong correspondence. For example, when tracking a planar textured object, fitness can be expressed as f(x)=e^{c(x)}−1, where c(x) denotes the normalized cross-correlation between the perceived image and the model texture translated and rotated according to x.

Estimating the optimal parameter vector x is typically implemented using Bayesian estimators (e.g., particle filters) or optimization methods (e.g., genetic optimization, simulated annealing). The methods produce samples (guesses) of x, compute f(x) for the samples and then try to refine the guesses based on the computed fitness function values. However, all the prior methods have the problem that they “act blind”, that is, they select some portion of the search space (the possible values of x) and then randomly generate a sample within the portion. The sampling typically follows some kind of a sampling distribution, such as a normal distribution or uniform distribution centered at a previous sample with a high f(x).

To focus samples on promising parts of the parameter space, traditional computer vision systems use rejection sampling, that is, each randomly generated sample is rejected and re-generated until the sample meets a suitability criterion. For example, when tracking a face so that the parameterization is x=[x₀,y₀,scale] (each sample contains the two-dimensional coordinates and scale of the face), the suitability criterion may be that the input image pixel at location x₀,y₀ must be of face color. However, obtaining a suitable sample may require several rejected samples and thus an undesirably high amount of computing resources.

An alternative traditional method is Gibbs sampling where marginal distributions of the image x and y are pre-computed. If the samples need to be confined inside a rectangular portion of the image, the marginal distributions can be computed accordingly. However, unless one re-computes the marginal distributions for each sample, Gibbs sampling is limited to always drawing samples within the same portion, whereas it would be ideal to generate each sample within a different portion suggested by an optimization system or a Bayesian estimator. Thus, there is an obvious need for enhanced methods for generating parameter samples in model-based computer vision.

### SUMMARY

The invention discloses a method for tracking a target in model-based computer vision. The method according to the present invention comprises acquiring an input image. An integral image is then generated based on the input image. Then the initial portion is chosen. The initial portion is then split into new portions. For each new portion, the definite integral corresponding to the portion is determined using an integral image. Based on the integral new portion is chosen for processing. The sequence of splitting, computing and selecting is repeated until a termination condition has been fulfilled.

In an embodiment of the invention the termination condition is the number of passes or a minimum size of a portion. In a further embodiment of the invention the selection probability of a portion is proportional to the determined definite integral corresponding to the portion. In an embodiment of the invention the portions are rectangles. In an embodiment of the invention the definite integral corresponding to a rectangle is determined as iᵢ(x₂,y₂)−iᵢ(x₁,y₂)−iᵢ(x₂,y₁)+i₁(x₁,y₁), where x₁,y₁ and x₂,y₂ are the coordinates of the corners of the rectangle, and iᵢ(x,y) is the intensity of the integral image at coordinates x,y. In a typical embodiment of the invention the selected portion is chosen among the new portions.

In an embodiment of the invention integral images are generated by using at least one of the following methods: processing the input image with an edge detection filter; comparing the input image to a model of the background; or subtracting consecutive input images to obtain a temporal difference image.

1. In an embodiment of the invention at least one parameter of a model of the tracked target is determined based on the last selected portion. In a further embodiment at least one model parameter is determined by at least one of the following methods: setting a parameter proportional to the horizontal or vertical location of the last selected portion; or setting a parameter proportional to the horizontal or vertical location of a point randomly selected within the last selected portion.

In an embodiment of the invention the method described above is implemented in the form of software. A further embodiment of the invention is a system comprising a computing device having said software. The system according to the invention typically includes a device for acquiring images, such as an ordinary digital camera being capable of acquiring single images and/or continuous video sequence.

The present invention particularly improves the generation of samples in Bayesian estimation of model parameters so that the samples are likely to have strong evidence based on the input image. Previously, rejection sampling and Gibbs sampling have been used for this purpose, but the present invention requires considerably less computing power.

The benefit of the present invention is that it requires considerably less resources than conventional methods. Thus, with same resources it is capable of producing better quality results or it can be used for providing the same quality with reduced resources. This is particularly beneficial in devices having low computing power, such as mobile devices.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention

FIG. 2 is a flow chart of the method disclosed by the invention

FIG. 3 is an example visualization of the starting conditions for the present invention

FIG. 4 is an example of the results of the present invention according to the starting conditions of FIG. 3.

### DETAILED DESCRIPTION OF THE INVENTION

Reference will now be made in detail to the embodiments of the present invention, examples of which are illustrated in the accompanying drawings.

In model-based computer vision, the present invention allows the generation of model parameter samples to use image features as a prior probability distribution. For example, if some parameters x⁽ⁱ⁾, x^{(j)} denote the horizontal and vertical coordinates of a face of a person, it is reasonable to only generate samples where the input image pixel at coordinates x⁽ⁱ⁾, x^{(j)} is of face color.

In an embodiment of the invention, a model parameter vector sample is generated so that an image coordinate pair is sampled within a portion of an image, and the coordinates are then mapped to a number of model parameters, either directly or using some mapping function. For example, when tracking a planar textured target, the model parameterization may be x=[xᵥ,yᵥ,z,rₓ,r_{y},r_{z}], where xᵥ,yᵥ are the viewport (input image) coordinates of the model, z is the z-coordinate of the model, and rₓ,r_{y},r_{z} are the rotations of the model. In this case, for each parameter vector sample, xᵥ,yᵥ can be generated using the present invention, and the other parameters can be generated using traditional means, such as by sampling from a normal distribution suggested by a Bayesian estimator. To compute the fitness function f(x), the generated viewport coordinates can then be transformed into world coordinates using the generated z and prior knowledge of camera parameters. The correspondence between the model and the input image can then be computed by projecting the model to the viewport and computing the normalized cross-correlation between the input image pixels and the corresponding model pixels.

The present invention is based on the idea of decomposing sampling from a real-valued multimodal distribution into iterated draws from binomial distributions. If p(x) is a probability density function, samples from the corresponding probability distribution can be drawn according to the following pseudo-code:

```
  Starting with an initial portion R of the space of
acceptable values for x, repeat{
  Divide R into portions A and B;
  Compute the definite integrals I_{A} and I_{B} of p(x) over the
  the portions A and B;
  Assign A the probability I_{A}/(I_{A}+I_{B}) and B the probability
  I_{B}/(I_{A}+I_{B});
  Randomly set R=A or R=B according to the probabilities;
}
```

After iterating sufficiently, R becomes very small and the sample can then be drawn, for example, uniformly within R, or the sample may be set equal to the center of R.

It should be noted that the step of randomly setting R=A or R=B according to the probabilities may be implemented, for example, by first generating a random number n in the range 0 . . . I_{A}+I_{B}, and then setting R=A if n<I_{A}, and otherwise setting R=B.

The division of R into portions may be done, for example, by splitting R into two halves along a coordinate axis of the search space. The halves may be of equal size, or the splitting position may be deviated around a mean value in a random manner.

The present invention concerns particularly the case when p(x)=p(x,y) denotes the intensity (pixel value) of an image at pixel coordinates x,y. An image denotes here a pixel array stored in a computer memory. One can use integral images to implement the integral evaluation efficiently. An integral image is a pre-computed data structure, a special type of an image that can be used to compute the sum of the pixel intensities within a rectangle so that the amount of computation is independent of the rectangle size. Integral images have been used, e.g., in Haar-feature based face detection by Viola and Jones.

An integral image is computed from some image of interest. The definite integral (sum) of the pixels of the image of interest over a rectangle R can then be computed as a linear combination of the pixels of the integral image at the rectangle corners. This way, only four pixel accesses are needed for a rectangle of an arbitrary size. Integral images may be generated, for example, using many common computer vision toolkits, such as the OpenCV (Open Computer Vision library). If i(x,y) denotes the pixel intensity of an image of interest, and iᵢ(xᵢ,yᵢ) denotes the pixel intensity of an integral image, one example of computing the integral image is setting iᵢ(xᵢ,yᵢ) equal to the sum of the pixel intensities i(x,y) within the region x<xᵢ, y<yᵢ. Now, the definite integral (sum) of i(x,y) over the region x₁≦x<x₂, y₁≦y<y₂ can be computed as iᵢ(x₂,y₂)−iᵢ(x₁,y₂)−iᵢ(x₂,y₁)+iᵢ(x₁,y₁).

One may also compute a tilted integral image for evaluating the integrals of rotated rectangles by setting iᵢ(xᵢ,yᵢ) equal to the sum of the pixel intensities i(x,y) within the region |x−xᵢ|<y, y<yᵢ.

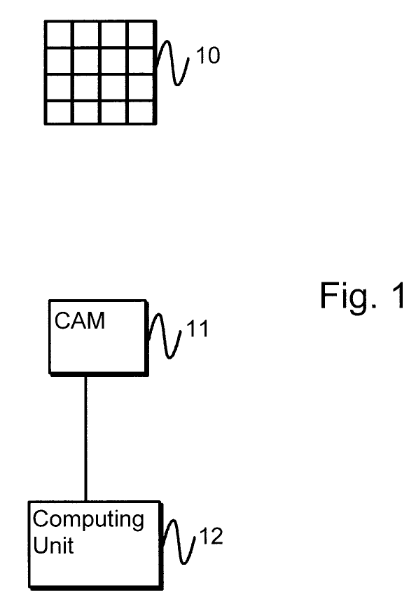

In FIG. 1, a block diagram of an example embodiment according to the present invention is disclosed. The example embodiment comprises a model or a target 10, an imaging tool 11 and a computing unit 12. The target 10 is in this application a checker board. However, the target may be any other desired target that is particularly made for the purpose or a natural target, such as a face, or a selected portion of an image. The imaging tool may be, for example, an ordinary digital camera that is capable of providing images at desired resolution and rate. The computing unit 12 may be, for example, an ordinary computer having enough computing power to provide the result at the desired quality. Furthermore, the computing device includes common means, such as a processor and memory, in order to execute a computer program or a computer implemented method according to the present invention. Furthermore, the computing device includes storage capacity for storing target references. The system according to FIG. 1 may be used in computer vision applications for detecting or tracking a particular object that may be chosen depending on the application. The dimensions of the object are chosen correspondingly.

In an embodiment of the invention, generating a parameter vector sample for model-based computer vision may proceed according to the following pseudo-code:

```
Compute an integral image based on the input image provided
by the imaging tool 11;
Select an initial rectangle R, for example, as suggested by
an optimization method or a Bayesian estimator;
Repeat until a termination condition has been fulfilled {
  Split R into new rectangles A and B;
  Compute the definite integrals I_{A} and I_{B} over the
  rectangles A and B using the integral image;
  Assign A the probability I_{A} and B the probability I_{B};
  Randomly set R=A or R=B according to the probabilities;
}
Determine at least one model parameter based on R;
```

The termination condition may be, for example, a maximum number of iterations or a minimum size of R.

The computing of the integral image may use the input image as the image of interest, or first process the input image to yield the image of interest. The processing may comprise any number of computer vision methods, such as edge detection, background subtraction, or motion detection. For example, if the tracked object is green and the model parameters include the horizontal and vertical coordinates of the object, the intensity of the image of interest at coordinates x,y may be set to max[0,G_{x,y}−(R_{x,y}+B_{x,y})], where R_{x,y}, G_{x,y}, B_{x,y} denote the intensity of the red, green and blue colors of the input image at coordinates x,y. In this case, at the end of the pseudocode, the coordinate parameters may be easily determined from R, for example, by setting them equal (or proportional) to the center coordinates of R, or by randomly selecting them within R.

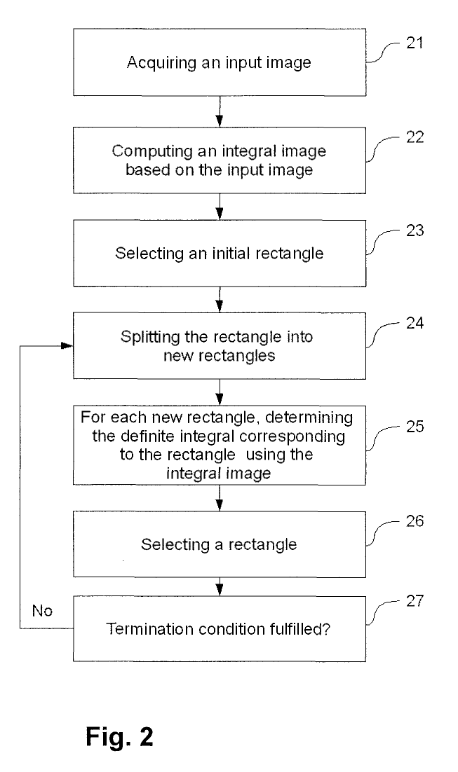

FIG. 2. shows a flowchart of an embodiment of the invention, comprising the acquiring of input image 21, computing an integral image based on the input image 22, selecting an initial rectangle 23, e.g., based on the sampling distribution determined by a model parameter estimator, splitting the rectangle into new rectangles 24, determining the definite integral of the image of interest over the new rectangles 25, selecting a rectangle 26, and checking the termination condition 27.

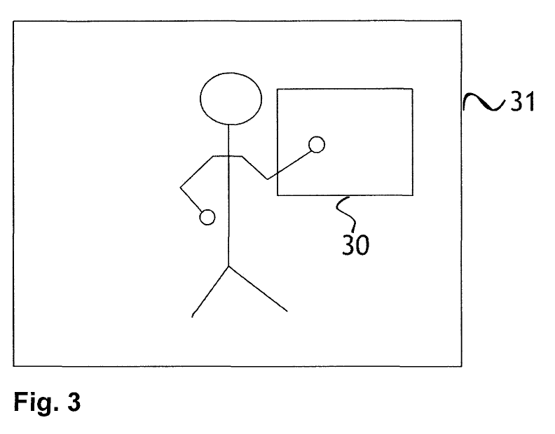

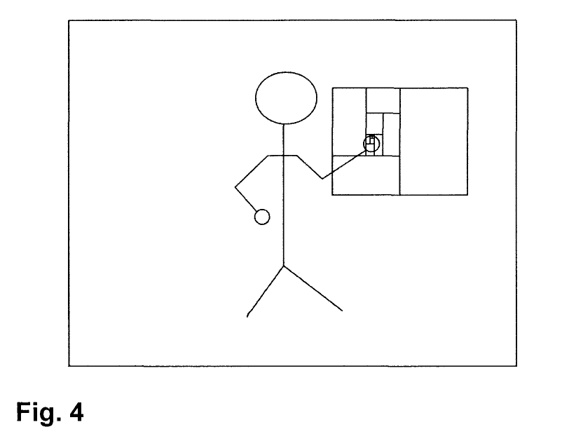

FIG. 3 shows an example of starting the pseudocode with initial rectangle 30 and image of interest obtained using an edge detector. FIG. 4 shows an example of how the initial rectangle may be split into smaller rectangles according to the present invention, finally converging on a non-zero pixel of the image of interest.

The present invention can be applied to boost the performance of existing Bayesian estimators or stochastic optimization methods. Many such methods, such as Simulated Annealing and particle filters, contain a step where a new sample is drawn from a sampling distribution with statistics computed from previous samples. For example, the sampling distribution may be a uniform distribution centered at the previous sample. The present invention may then be used by selecting the initial rectangle R based on the sampling distribution. In an embodiment of the invention, the model parameters x may contain an image coordinate pair x,y, and the sampling distribution for the x,y may be any distribution with a mean μₓ, μ_{y} and stdev sₓ, s_{y}. The initial rectangle R may then be centered at μₓ, μ_{y} and its width and height may be proportional to sₓ, s_{y}. After iterating the loop of the pseudocode sufficiently many times, one may then, for example, sample x,y uniformly within R, or set x,y equal to the center coordinates of R.

If the sampling distribution is not uniform, the initial rectangle may be selected randomly so that the probability of a point belonging inside the initial rectangle follows the sampling distribution. For example, if the initial rectangle is of fixed size, the probability density of the center coordinates of the rectangle should be equal to the deconvolution of the sampling probability density and a rectangular window function having the same size as the initial rectangle.

For example, when tracking a face, the parameterization may be x=[x₀,y₀,scale] (each sample contains the two-dimensional coordinates and scale of the face). To generate a sample x, one may sample scale from the sampling distribution, and then use the present invention to sample x₀,y₀ by first processing the input image to yield an image that has high intensity at areas that are of face color in the input image. An integral image can then be computed from the processed image and x₀,y₀ can be determined according to the pseudocode above.

In many computer vision systems, hundreds of samples need to be generated for each input image. It should be noted that the integral image needs to be computed only once for each input image, not for each sample.

In general, obtaining model parameters according to the present invention may require an embodiment of the invention to employ a variety of mappings between the parameter space and image space. Instead of selecting and splitting rectangles, one may select and split portions of any shape, in which case “portion” should be substituted in place of “rectangle” in the pseudocode above. For example, selecting the initial portion may be done by first selecting an portion of a higher-dimensional parameter space based on a Bayesian estimator, and then mapping the higher dimensional portion to the initial portion. After splitting and selecting image portions according to the pseudocode above, a point may be selected within the last selected portion. The coordinates of the selected point may then be mapped back to model parameters.

For example, in an embodiment illustrated by FIG. 4., the tracked target may be a colored glove, in which case the location of the last selected portion directly corresponds to the location of the target and model. In an advanced embodiment, the target may be a human body, in which case the location of the last selected portion may indicate the location of a hand or other part of the body in the camera view, and the body model parameters may be solved accordingly. For example, the vertex coordinates y of a polygon model may depend on the model parameters x in a linear fashion, e.g., y=Ax. In an embodiment of the invention, the location of the last selected portion represents two elements of y, which can be used to solve at least one element of x.

In an embodiment of the invention, after determining at least one model parameter as disclosed above, the correspondence between the model and an image is determined, e.g., using normalized cross-correlation. A value indicating the correspondence may then be then passed to the Bayesian estimation or optimization system that was used to determine the initial portion. The Bayesian estimation or optimization may then use the value and the model parameters to determine the initial portion for generating the next parameter vector sample.

It is obvious to a person skilled in the art that with the advancement of technology, the basic idea of the invention may be implemented in various ways. The invention and its embodiments are thus not limited to the examples described above; instead they may vary within the scope of the claims.

1-28. (canceled)

29. A method for tracking a target in computer vision, the method comprising:
acquiring an input image;
generating an integral image based on the input image;
selecting an initial portion;
characterized in that the method further comprises:
splitting the selected portion into new portions;
for each new portion, using the integral image to determine the definite integral corresponding to the portion;
selecting a portion from said split portions;
repeating the sequence of said splitting, determining and selecting until a termination condition has been fulfilled;

30. The method according to claim 29, characterized in that the termination condition is the number of passes or a minimum size of a portion.

31. The method according to claim 29, characterized in that the selection probability of a portion is proportional to the determined definite integral corresponding to the portion.

32. The method according to claim 29, characterized in that the portions are rectangles.

33. The method according to claim 32, characterized in that the definite integral corresponding to a rectangle is determined as iᵢ(x₂,y₂)−iᵢ(x₁,y₂)−iᵢ(x₂,y₁)+iᵢ(x₁,y₁), where x₁,y₁ and x₂,y₂ are the coordinates of the corners of the rectangle, and iᵢ(x,y) is the intensity of the integral image at coordinates x,y.

34. The method according to claim 29, characterized in that choosing the selected portion among the new portions.

35. The method according to claim 29, characterized in that generating at least one integral image by using at least one of the following methods:
processing the input image with an edge detection filter;
comparing the input image to a model of the background; or
subtracting consecutive input images to obtain a temporal difference image.

36. The method according to claim 29, characterized in that the method further comprises determining at least one parameter of a model of the tracked target based on the last selected portion.

37. The method according to claim 36, characterized in that determining at least one parameter of a model of the tracked target using at least one of the following methods:
setting a parameter proportional to the horizontal or vertical location of the last selected portion; or
setting a parameter proportional to the horizontal or vertical location of a point randomly selected within the last selected portion.

38. A computer program for tracking a target in computer vision embodied in a computer readable medium, wherein the computer program is embodied on a computer-readable medium comprising program code means adapted to perform the following steps when the program is executed in a computing device:
acquiring an input image;
generating an integral image based on the input image;
selecting an initial portion;
characterized in that the method further comprises:
splitting the selected portion into new portions;
for each new portion, using the integral image to determine the definite integral corresponding to the portion;
selecting a portion from said split portions;
repeating the sequence of said splitting, determining and selecting until a termination condition has been fulfilled.

39. The computer program according to claim 38, characterized in that the termination condition is the number of passes or a minimum size of a portion.

40. The computer program according to claim 38, characterized in that the selection probability of a portion is proportional to the determined definite integral corresponding to the portion.

41. The computer program according to claim 38, characterized in that the portions are rectangles.

42. The computer program according to claim 41, characterized in that the definite integral corresponding to a rectangle is determined as iᵢ(x₂,y₂)−iᵢ(x₁,y₂)−iᵢ(x₂,y₁)+iᵢ(x₁,y₁), where x₁,y₁ and x₂,y₂ are the coordinates of the corners of the rectangle, and iᵢ(x,y) is the intensity of the integral image at coordinates x,y.

43. The computer program according to claim 38, characterized in that the selected portion is chosen among the new portions.

44. The computer program according to claim 38, characterized in that generating at least one integral image by using at least one of the following methods:
processing the input image with an edge detection filter;
comparing the input image to a model of the background; or
subtracting consecutive input images to obtain a temporal difference image.

45. The computer program according to claim 38, characterized in that the program further comprises determining at least one parameter of a model of the tracked target based on the last selected portion.

46. The computer program according to claim 45, characterized in that determining at least one parameter of a model of the tracked target using at least one of the following methods:
setting a parameter proportional to the horizontal or vertical location of the last selected portion; or
setting a parameter proportional to the horizontal or vertical location of a point randomly selected within the last selected portion.

47. A system for tracking a target in computer vision, wherein the system comprises means for receiving and processing data, which system is configured to:
acquire an input image;
generate an integral image based on the input image;
select an initial portion;
characterized in that the system is further configured to:
split the selected portion into new portions;
for each new portion, use the integral image to determine the definite integral corresponding to the portion;
select a portion from said split portions;
repeat the sequence of said splitting, determining and selecting until a termination condition has been fulfilled.

48. The system according to claim 47, characterized in that the termination condition is the number of passes or a minimum size of a portion.

49. The system according to claim 47, characterized in that the selection probability of a portion is proportional to the determined definite integral corresponding to the portion.

50. The system according to claim 47, characterized in that the portions are rectangles.

51. The system according to claim 50, characterized in that the definite integral corresponding to a rectangle is determined as iᵢ(x₂,y₂)−iᵢ(x₁,y₂)−iᵢ(x₂,y₁)+iᵢ(x₁,y₁), where x₁,y₁ and x₂,y₂ are the coordinates of the corners of the rectangle, and iᵢ(x,y) is the intensity of the integral image at coordinates x,y.

52. The system according to claim 47, characterized in that the selected portion is chosen among the new portions.

53. The system according to claim 47, characterized in that system is configured to generate at least one integral image by using at least one of the following methods:
processing the input image with an edge detection filter;
comparing the input image to a model of the background; or
subtracting consecutive input images to obtain a temporal difference image.

54. The system according to claim 47, characterized in that the system is further configured to determine at least one parameter of a model of the tracked target based on the last selected portion.

55. The system according to claim 54, characterized in that the system is configured to determine at least one parameter of a model of the tracked target using at least one of the following methods:
setting a parameter proportional to the horizontal or vertical location of the last selected portion; or
setting a parameter proportional to the horizontal or vertical location of a point randomly selected within the last selected portion.

56. The system according to claim 47, wherein the system is a computing device.
